(19) United States
(12) Patent Application Publication
(10) Pub. No.: US 2007/0141981 A1
(43) Pub. Date: Jun. 21, 2007

(54) Digital multimedia broadcast receiving device executing function of sleep reservation, and sleep reservation method thereof

(75) Inventor: Kang-Sun Choi, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/640,757

(22) Filed: Dec. 18, 2006

(30) Foreign Application Priority Data
Dec. 16, 2005 (KR) 2005-0124825

(51) Int. Cl. H04H 7/00; H04M 1/00

(52) U.S. Cl. 455/3.06; 455/556.1

(57) ABSTRACT

Provided is a device for receiving a digital multimedia broadcast, and a sleep reservation method thereof. The device includes an external instrument interface unit for receiving and converting a broadcast signal into a signal reproducible in an external instrument, and transmitting the converted signal to the external instrument; a key input unit for receiving a broadcast reception end time to set a sleep reservation time; a memory for storing the received broadcast reception end time; a controller for, upon the arrival of the broadcast reception end time, ending broadcast reception and requesting switching off a power supply of the external instrument; and a wireless signal transmitter for generating a message in response to a request of the controller, and transmitting the message to the external instrument.

### PRIORITY

This application claims priority under 35 U.S.C., § 119 to an application entitled “Digital Multimedia Broadcast Receiving Device Executing Function of Sleep Reservation, and Sleep Reservation Method Thereof” filed in the Korean Intellectual Property Office on Dec. 16, 2005 and assigned Serial No. 2005-124825, the contents of which are incorporated herein by reference.

### BACKGROUND OF THE INVENTION

1. Field of the Invention

The present invention relates generally to a sleep reservation method in a Digital Multimedia Broadcast (DMB) receiving device, and more particularly, to a method for not only ending broadcast reception at a reserved broadcast reception end time after the DMB receiving device is set in a sleep reservation mode, but also at the same time, switching off even a power supply of an external instrument to receive a broadcast signal from the DMB receiving device and output the received broadcast signal.

2. Description of the Related Art

Digital Multimedia Broadcast (DMB) is becoming common, and a user can now use moving picture and data information such as weather, news, and position information with compact disk (CD)/digital video disk (DVD)-class high fidelity and high definition, using a DMB receiving device, even while moving. The user is allowed to view even conventional sky wave, cable, and satellite broadcast programs using DMB. In general, the user views DMB using a DMB receiving device while moving, and can also view the broadcast program in his/her house and office, using an external instrument with a large size display such as a television.

FIG. 1 is a block diagram illustrating a conventional DMB receiving device 100 for outputting a broadcast signal to an external instrument 300 through an external instrument interface unit 180 provided in the DMB receiving device 100.

In FIG. 1, the conventional DMB receiving device 100 additionally includes the external instrument interface unit 180 such as a TV-OUT terminal having a function relating to an output of the broadcast signal, and outputs not only a broadcast but also a moving picture, a photograph, and a voice to an external video media device such as a television (TV) 300.

The conventional DMB receiving device 100 capable of outputting the broadcast signal will be described, and includes a portable phone antenna 105, a wireless processor 115, a DMB antenna 110, a digital broadcast receiver 120, a demodulator 130, a controller 140, a memory 150, a key input unit 160, an output unit 170, and the external instrument interface unit 180.

The portable phone antenna 105 is a common portable phone antenna for receiving a wireless signal such as an origination call and a short message service (SMS) from a base station, and outputting the received wireless signal to the wireless processor 115. The wireless processor 115 processes the received signal from the portable phone antenna 105, and transmits the processed signal to the controller 140 so that the controller 140 performs its related operation.

The digital broadcast receiver 120 receives a plurality of digital broadcast signals through the DMB antenna 110, demultiplexes at least one digital broadcast signal desired by a user, and outputs the demultiplexed broadcast signal to the demodulator 130. The demodulator 130 decodes a DMB transmission frame received from the digital broadcast receiver 120, and outputs the decoded frame to the output unit 170 with a speaker (not shown) and a liquid crystal display (LCD) (not shown) under the control of the controller 140.

The DMB receiving device 100 is connected to the external instrument 300 by wire or wirelessly for a viewer to view a broadcast using the external instrument 300 with a large size display. The controller 140 converts the DMB transmission frame output from the demodulator 130 into data of a format which can be processed by the external instrument 300, and outputs the converted data to the external instrument 300 with the large size display connected through the external instrument interface unit 180. At the same time, it can output the converted data to the output unit 170 of the DMB receiving device 100.

Under the circumstances where the broadcast program is viewed through the external instrument 300 as above, the DMB receiving device 100 can be set in a sleep reservation mode. This is because a function of receiving and processing the DMB signal executed with great power consumption results in the problem that, when the user sleeps while viewing the broadcast, a morning call or wake-up call function does not work due to battery discharge, or incoming telephone calls can not be answered.

Accordingly, the DMB receiving device 100 being set in the sleep reservation mode, upon the arrival of a set time after a predetermined time, stops an operation of a module receiving and processing the DMB signal such as the digital broadcast receiver 120 and the demodulator 130. While so, the DMB receiving device 100 keeps a module to process a general portable phone function like telephoning and SMS transmission and reception other than a DMB related function, in an idle mode or power saving mode so that it is activated immediately when called, and normally operated.

However, the conventional DMB receiving device 100 can be set in the sleep reservation mode under circumstances where the broadcast program is viewed through the external instrument, and can end the broadcast reception itself upon the arrival of a reserved broadcast reception end time, but may fail to switch off the power supply of the external instrument, such as a television, which results in a waste of power and user inconvenience. The switching off of the power supply of the external instrument usually requires once more setting the sleep reservation mode to the external instrument itself. Thus, the setting of the sleep reservation mode to the DMB receiving device requires the user to not only end a broadcast reception operation of a DMB terminal, but also at the same time, to switch off the power supply of the external instrument.

### SUMMARY OF THE INVENTION

It is, therefore, an object of the present invention to provide a Digital Multimedia Broadcast (DMB) receiving device and method for not only ending broadcast reception at a reserved broadcast reception end time after the DMB receiving device is set in a sleep reservation mode, but also at the same time, switching off a power supply of an external instrument which receives a broadcast signal from the DMB receiving device and output the received broadcast signal.

To achieve the above and other objects, there is provided a device for receiving a digital multimedia broadcast. The device includes an external instrument interface unit for receiving and converting a broadcast signal into a signal reproducible in an external instrument, and transmitting the converted signal to the external instrument; a key input unit for receiving a broadcast reception end time to set a sleep reservation time; a memory for storing the received broadcast reception end time; a controller for, upon the arrival of the broadcast reception end time, ending broadcast reception and requesting switching off a power supply of the external instrument; and a wireless signal transmitter for generating a message in response to a request of the controller, and transmitting the message to the external instrument.

In another aspect of the present invention, there is provided a method for executing a sleep reservation function in a Digital Multimedia Broadcast (DMB) receiving device. The method includes converting a broadcast signal into a signal reproducible in an external instrument, and transmitting the converted signal to the external instrument; receiving a broadcast reception end time to set a sleep reservation time; storing the received broadcast reception end time; upon the arrival of the broadcast reception end time, ending broadcast reception and generating a message requesting switching off a power supply of the external instrument; and transmitting the message to the external instrument.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a conventional Digital Multimedia Broadcast (DMB) receiving device for outputting a broadcast signal to an external instrument through an external instrument interface unit provided in the DMB receiving device;

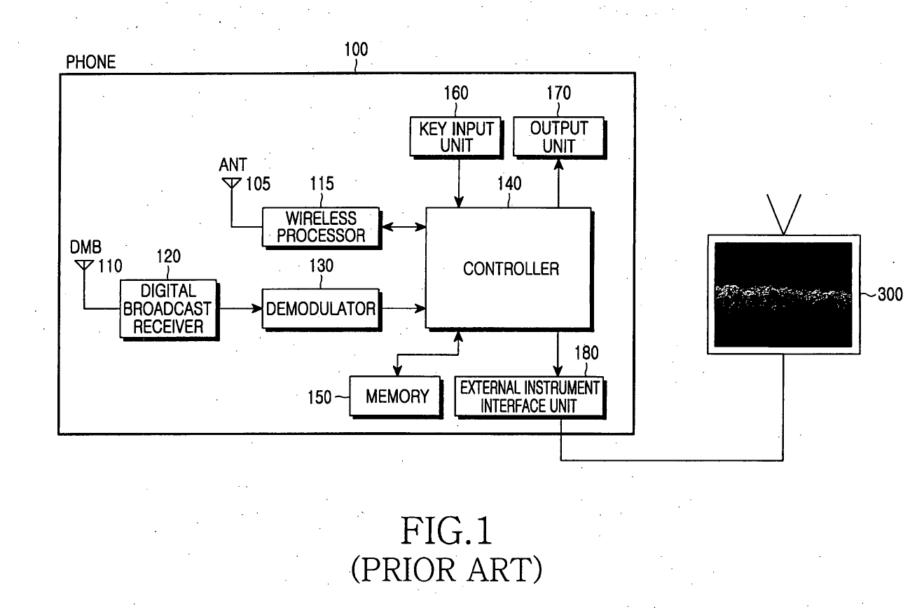

FIG. 2 is a block diagram illustrating a DMB receiving device for executing a sleep reservation function while outputting a broadcast to an external instrument according to the present invention; and

FIG. 3 is a flowchart illustrating a method for executing a sleep reservation function while outputting a broadcast to an external instrument according to of the present invention.

### DETAILED DESCRIPTION OF THE PREFERRED EMBODIMENT

A preferred embodiment of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for conciseness.

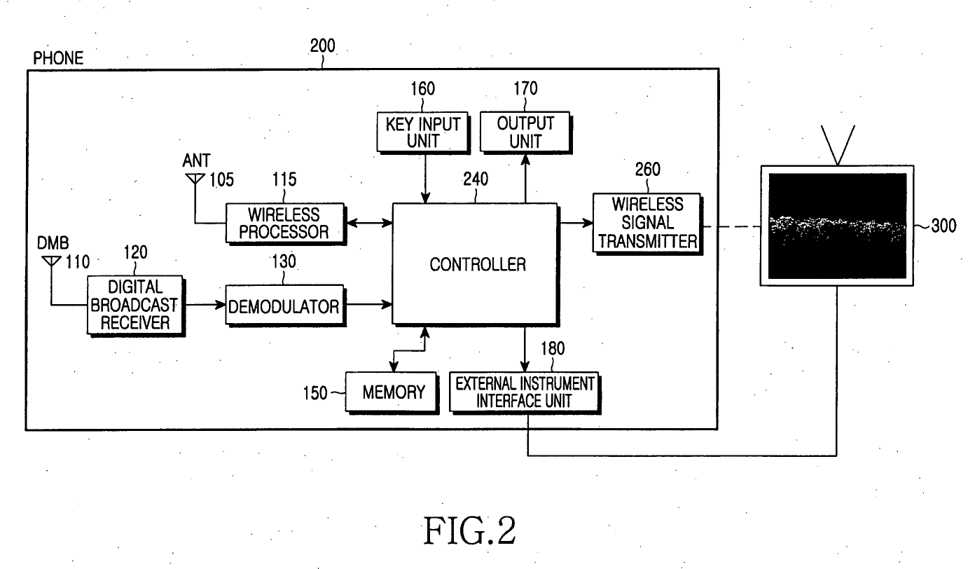

Referring to FIG. 2, a DMB receiving device 200 includes a portable phone antenna 105, a wireless processor 115, a DMB antenna 110, a digital broadcast receiver 120, a demodulator 130, a controller 240, a memory 150, a key input unit 160, an output unit 170, an external instrument interface unit 180, and a wireless signal transmitter 260.

The portable phone antenna 105 is a common portable phone antenna for receiving a wireless signal, such as an origination call and a short message service (SMS), from a base station, and outputting the received wireless signal to the wireless processor 115. The wireless processor 115 processes the signal received from the portable phone antenna 105, and transmits the processed signal to the controller 240 so that the controller 240 performs its relating operation.

The digital broadcast receiver 120 receives a plurality of digital broadcast signals through the DMB antenna 110, demultiplexes at least one digital broadcast signal desired by user, and outputs the demultiplexed broadcast signal to the demodulator 130. The demodulator 130 decodes a received DMB transmission frame, and outputs the decoded frame to the output unit 170 with a speaker (not shown) and a liquid crystal display (LCD) (not shown) through the controller 240.

The DMB receiving device 200 is connected to an external instrument 300 by wire or wirelessly for a viewer to view the broadcast using the external instrument 300 with a large size display. The controller 240 converts the DMB transmission frame outputted from the demodulator 130 into data of a format which can be processed by the external instrument 300, and outputs the converted data to the external instrument 300 with the large size display connected through the external instrument interface unit 180. At the same time, can output the converted data to the output unit 170 of the DMB receiving device 200.

The controller 240 stores a reserved broadcast reception end time in the memory 150 as a user sets a sleep reservation time input using the key input unit 160, and controls the digital broadcast receiver 120 and the demodulator 130 to end the reception and processing of the broadcast signal upon the arrival of the broadcast reception end time. At this time, the controller 240 can switch off a power supply to the digital broadcast receiver 120 and the demodulator 130, or stop those operations using software.

When the controller 240 stops the operations of the digital broadcast receiver 120 and the demodulator 130, the DMB receiving device 200 is converted to an idle mode or power saving mode. Other modules for executing other functions, such as telephoning and character transmission/reception other than the DMB function, can be activated any time when it is called.

The controller 240 can output an image that is set for the idle mode or power saving mode, to the output unit 170 or the external instrument interface unit 180, or can output no signal.

After stopping the operations of the digital broadcast receiver 120 and the demodulator 130, the controller 240 activates the wireless signal transmitter 260 to transmit a control message to the external instrument 300 using a wireless communication scheme such as Infrared Data Association (IrDA) or Bluetooth, in order to remotely control the connected external instrument 300, such as to switch off the power supply of the external instrument 300.

In response to a request of the controller 240, the wireless signal transmitter 260 reads the control message to switch off the power supply of the external instrument 300, from the memory 150 storing the control message, converts the message into the wireless signal to be transmitted based on the wireless communication scheme, and transmits the converted signal to the external instrument 300 using the wireless communication scheme, such as IrDA or Bluetooth.

The memory 150 stores broadcast reception end time setting information based on the user's setting for the sleep reservation time input using the key input unit 160, and previously stores information on the control message to control the external instrument 300. Thus, the control message responsive to the request of the controller 240 is read from the memory 150, and is transmitted to the external instrument 300 through the wireless signal transmitter 260.

In the present invention, the DMB receiving device 200 is a DMB phone which concurrently executes a function of a general portable phone and a function of a DMB receiving terminal. However, if the DMB receiving device 200 is not a DMB phone but is instead a DMB-only receiving terminal, it would not include the portable phone antenna 105 and the wireless processor 115.

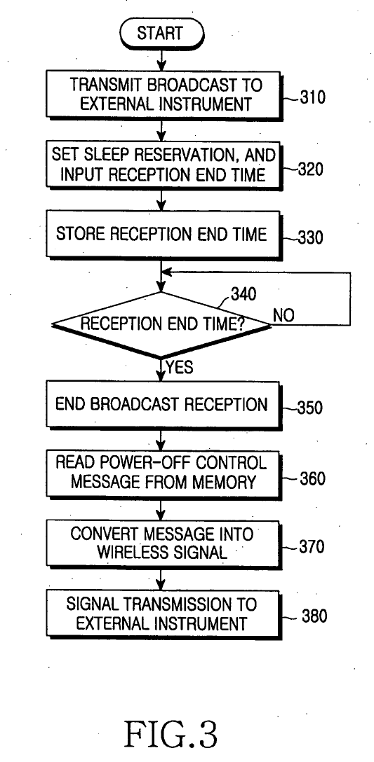

FIG. 3 is a flowchart illustrating a method for executing the sleep reservation function in the DMB receiving device according to the present invention.

In Step 310, the DMB receiving device outputs the broadcast signal to the connected external instrument for the viewer to view the received broadcast signal using the external instrument with the large size display.

Upon receipt of a reserved sleep time, that is, the broadcast reception end time input by a user for setting the sleep reservation time in Step 320, the broadcast reception end time is stored in the DMB receiving device in Step 330.

In Step 340, it is determined whether the broadcast reception end time has arrived. Upon the arrival of the end time, the reception and processing of the broadcast signal ends in Step 350. An operation of outputting the broadcast signal to the connected external instrument ends at the same time.

In Step 360, the previously stored control message for engaged the external instrument is read so as to remotely control the connected external instrument and switch off the power supply of the external instrument. The control message is converted into the transmissible wireless signal in Step 370, and is transmitted to the external instrument using the wireless communication scheme, such as IrDA or Bluetooth in Step 380.

As described above, the present invention can provide the DMB receiving device and method for not only ending broadcast reception at the reserved broadcast reception end time after the DMB receiving device is set in the sleep reservation mode, but also at the same time, switching off the power supply of the external instrument receiving the broadcast signal from the DMB receiving device.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A device for receiving a digital multimedia broadcast, the device comprising:
an external instrument interface unit for receiving and converting a broadcast signal into a signal reproducible in an external instrument, and transmitting the converted signal to the external instrument;
a key input unit for receiving a broadcast reception end time to set a sleep reservation time;
a memory for storing the received broadcast reception end time;
a controller for, upon arrival of the broadcast reception end time, ending broadcast reception and requesting switching off a power supply of the external instrument; and
a wireless signal transmitter for generating a message in response to a request of the controller, and transmitting the message to the external instrument.

2. The device of claim 1, wherein the wireless signal transmitter converts the message into a wireless signal, and transmits the converted signal to the external instrument using a wireless communication scheme, including one of IrDA (Infrared Data Association) and Bluetooth.

3. The device of claim 1, wherein the message is an external instrument power-off control message.

4. The device of claim 1, wherein the memory previously stores information on an external instrument control message.

5. A method for executing a sleep reservation function in a Digital Multimedia Broadcast (DMB) receiving device, the method comprising the steps of:
converting a broadcast into a signal reproducible in an external instrument, and transmitting the converted signal to the external instrument;
receiving a broadcast reception end time to set a sleep reservation time;
storing the received broadcast reception end time;
upon the arrival of the broadcast reception end time, ending broadcast reception and generating a message requesting switching off a power supply of the external instrument; and
transmitting the message to the external instrument.

6. The method of claim 5, wherein the message is a power-off control message.

7. The method of claim 6, wherein the power-off control message is previously stored in a memory.

8. The method of claim 5, wherein the message is converted into a wireless signal, and is transmitted to the external instrument using a wireless communication scheme, including one of IrDA and Bluetooth.

9. The method of claim 5, wherein, upon ending the broadcast reception, transmission of the broadcast to the external instrument is stopped.
